(19) United States
(12) Patent Application Publication
(10) Pub. No.: US 2024/0426602 A1
(43) Pub. Date: Dec. 26, 2024

(54) Laser Level with Direct Projection to Multiple Targets

(71) Applicant: Milwaukee Electric Tool Corporation, Brookfield, WI (US)

(72) Inventors: Austin Alexander Borkowski, Milwaukee, WI (US); Steven K. Hansen, Port Washington, WI (US); Benjamin D. Gabbard, Milwaukee, WI (US); Jacob D. Hadfield, Mukwonago, WI (US); Adam J. Sargis, Mount Pleasant, WI (US)

(21) Appl. No.: 18/661,133

(22) Filed: May 10, 2024

Related U.S. Application Data
(60) Provisional application No. 63/509,629, filed on Jun. 22, 2023.

(51) Int. Cl. G01B 11/26

(52) U.S. Cl. CPC G01B 11/26

(57) ABSTRACT

A laser level is provided that emits pulses of a laser beam at a mirror to generate multiple marked locations on a surface, such as a ceiling. The mirror rotates around an axis and includes multiple surfaces that face away from the axis. The laser pulses are bounced off the surfaces as the mirror rotates to produce the multiple marked locations.

### CROSS-REFERENCE TO RELATED PATENT APPLICATION

The present application claims the benefit of and priority to U.S. Application No. 63/509,629 filed on Jun. 22, 2023, which is incorporated herein by reference in its entirety.

### BACKGROUND OF THE INVENTION

The present disclosure is directed generally to laser levels. The present disclosure relates specifically to laser levels with direct projection to one or more target points that appear to be illuminated simultaneously.

### SUMMARY OF THE INVENTION

One embodiment of the invention relates to a laser beam generating device including a housing, a light directing element that rotates with respect to a rotational axis that extends through the light directing element, a laser diode configured to emit a laser beam at the light directing element, and a control device communicatively coupled to the laser diode. The control device is configured to control the laser diode to emit a plurality of laser pulses of the laser beam at the light directing element. The control device controls the timing of the plurality of laser pulses so that the plurality of laser pulses produces a plurality of marked locations on a work surface after interfacing with the light directing element.

Another embodiment of the invention relates to a laser beam generating device including a housing, a light directing element that rotates with respect to a rotational axis that extends through the light directing element, the light directing element including a plurality of exterior flat surfaces, a laser diode configured to emit a laser beam at the light directing element, and a control device communicatively coupled to the laser diode. The control device is configured to control the laser diode to emit a plurality of laser pulses of the laser beam at the light directing element. The control device controls the timing of the plurality of laser pulses so that each pulse of a first subset of the plurality of laser pulses is projected at a different surface of the plurality of exterior flat surfaces, and each pulse of the first subset of the plurality of laser pulses intersects a first location on a work surface after interfacing with the light directing element.

Another embodiment of the invention relates to a laser beam generating device including a housing, a light directing element that rotates with respect to a rotational axis that extends through the light directing element, the light directing element including a plurality of exterior flat surfaces, a laser diode configured to emit a laser beam at the light directing element, and a control device communicatively coupled to the laser diode. The control device is configured to control the laser diode to emit a plurality of laser pulses of the laser beam at a first surface of the plurality of exterior flat surfaces. The control device controls the timing of the plurality of laser pulses so that a first subset of the plurality of laser pulses interfaces with the first surface of the plurality of exterior flat surfaces and thereafter each pulse of the first subset of the plurality of laser pulses intersects the same location on a work surface after interfacing with the light directing element.

Another embodiment of the invention relates to a laser beam generating device including a housing, a mirror, such as a polygonal reflector, such as a polygonal mirror, that rotates with respect to a rotational axis that extends through the polygonal reflector, the polygonal reflector including a plurality of reflective flat surfaces that circumferentially surround and face away from the rotational axis. The laser beam generating device includes a laser diode configured to emit a laser beam at the polygonal reflector, and a control device communicatively coupled to the laser diode. The control device is configured to control the laser diode to emit a plurality of laser pulses of the laser beam at the polygonal reflector, and the control device controls the timing of the plurality of laser pulses so that the laser beam reflects off the polygonal reflector to produce a plurality of distinct and spaced-apart marked locations on a work surface, such as a ceiling.

In various embodiments, a first subset of the plurality of laser pulses reflect off a first surface of the plurality of reflective flat surfaces to produce the plurality of marked locations. In various embodiments, a second subset of the plurality of laser pulses reflect off a second surface of the plurality of reflective flat surfaces to produce the plurality of marked locations, and the first subset is distinct from the second subset, and the first surface is distinct from the second surface. In various embodiments, the polygonal reflector is a mirror and the plurality of reflective flat surfaces are external reflective flat surfaces. In various embodiments, the rotational axis of the polygonal reflector is a non-vertical rotational axis, and specifically is a horizontal rotational axis, perpendicular to a vertical axis defined by gravity.

Another embodiment of the invention relates to a laser beam generating device including a housing, a reflector, such as a polygonal mirror, that rotates with respect to a rotational axis that extends through the reflector. The reflector includes a plurality of reflective flat surfaces that circumferentially surround and face away from the rotational axis. The laser beam generating device includes a laser diode configured to emit a laser beam at the reflector and a control device communicatively coupled to the laser diode. The control device is configured to control the laser diode to emit a plurality of laser pulses of the laser beam at the reflector. The control device controls the timing of the plurality of laser pulses so that each pulse of the plurality of laser pulses is projected at a different surface of the plurality of reflective flat surfaces, and each pulse of the plurality of laser pulses intersects the same location on a work surface.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a laser level, according to an exemplary embodiment.

FIG. 2 is a schematic side view of a portion of the laser level of FIG. 1, according to an exemplary embodiment.

FIG. 3 is a representation of laser pulses from the laser level of FIG. 1, according to an exemplary embodiment.

FIG. 4 is several representations of laser pulses and output from a tachometer from the laser level of FIG. 1, according to an exemplary embodiment.

FIG. 5 is several representations of laser pulses and output from a tachometer from the laser level of FIG. 1, according to an exemplary embodiment.

FIG. 6 is an exemplary image of a laser pulse from a laser beam from the laser level of FIG. 1 intersecting a work surface, according to an exemplary embodiment.

FIG. 7 is a perspective view of several components of the laser level of FIG. 1, according to an exemplary embodiment.

FIG. 8 is a perspective view of several components of the laser level of FIG. 1, according to an exemplary embodiment.

FIG. 9 is a schematic view of the laser level of FIG. 1, according to an exemplary embodiment.

FIG. 10 is a schematic view of the laser level of FIG. 1, according to an exemplary embodiment.

FIG. 11 is a schematic view of a second laser level, according to an exemplary embodiment.

FIG. 12 is a schematic view of the laser level of FIG. 11, according to an exemplary embodiment.

### DETAILED DESCRIPTION

Referring generally to the figures, various embodiments of a laser level are shown. As will generally be understood, laser levels are used to align objects or features in an area (e.g., such as holes along a wall, pipe, conduit, etc.).

In various embodiments, the laser level described herein is configured to emit a laser at a series of target points identified by the user. The laser is redirected by a light directing element, such as via laser projecting light off a rotating mirror, such as a polygonal mirror with multiple surfaces. The laser level includes a controller that controls a laser diode to emit pulses of a laser beam at the light directing element, and the controller times the pulses to be redirected by the light directing element to marked locations on a work surface, such as a ceiling. Although the laser level sequentially cycles through emitting light at each of the marked locations, the user perceives each of the marked locations as being present concurrently because of how quickly the laser level cycles between emitting light at each of the marked locations.

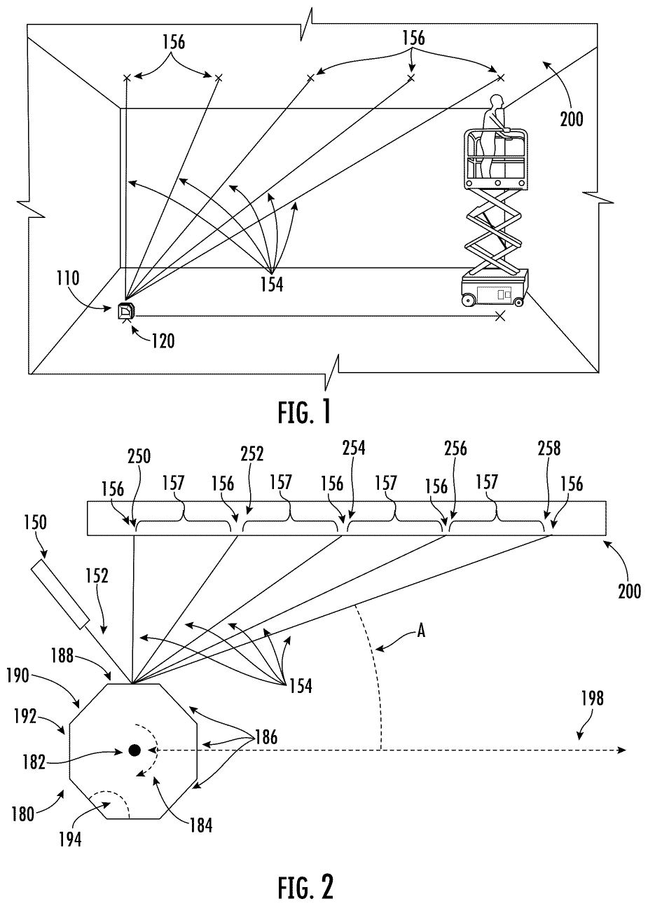

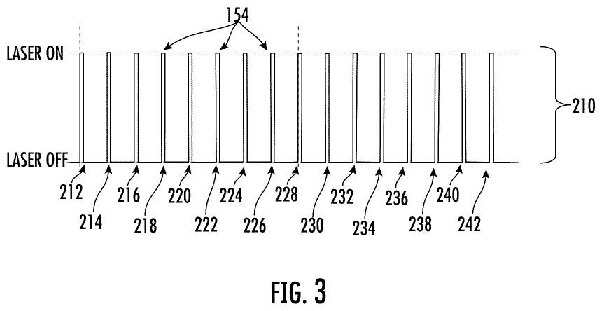

Referring to FIGS. 1-2, various aspects of laser level 110 are shown. Laser level 110 includes housing 120, a laser diode 150, and a light directing element, shown as mirror 180. Laser diode 150 is configured to emit a laser beam 152 at mirror 180 that rotates in direction 184 with respect to rotational axis 182 that extends through mirror 180. As will be explained, laser level 110 emits a plurality of laser pulses 154 of laser beam 152, and the timing of the plurality of laser pulses 154 are controlled (such as by control device 130) so that laser beam 152 produces a plurality of marked locations 156 on a work surface 200, such as a ceiling.

In various embodiments, rotational axis 182 is a horizontal axis. In particular, rotational axis 182 extends perpendicular, or generally perpendicular (e.g., within X degrees, such as within 1 degree) to the force of gravity. Thus, as mirror 180 rotates with respect to rotational axis 182, surfaces 186 of mirror 180 alternate between facing upward, sideways, and downward.

In a specific embodiment, mirror 180 is a polygonal mirror that includes a plurality of exterior reflective flat surfaces 186 that circumferentially surround and face away from the rotational axis 182, including first surface 188, second surface 190, and third surface 192, and the plurality of laser pulses 154 interfacing with the light directing element, shown as mirror 180, includes the plurality of laser pulses 154 reflecting off mirror 180. In various embodiments, the exterior reflective flat surfaces 186 are symmetrically arranged around rotational axis 182. In a specific embodiment, each surface 186 defines angle 194 with respect to each of the neighboring surfaces 186, such as mirror 180 including eight surfaces 186 and each surface 186 defining an angle 194 of 135 degrees with respect to each of the neighboring surfaces 186.

With reference to FIG. 2, in use laser diode 150 emits pulses 154 at surfaces 186 as mirror 180 rotates. For example, if laser diode 150 is producing five marked locations 156, laser diode 150 emits a first set of five pulses 154 at first surface 188, with each of the five pulses 154 timed as mirror 180 rotates so that the pulse 154 reflects off first surface 188 to produce a different one of each of the five marked locations 156. As mirror 180 continues to rotate in direction 184 with respect to axis 182, laser diode 150 emits a second set of five pulses at second surface 190. Similar to the first set of pulses 154, the second set of pulses 154 are timed so that the pulse 154 reflects off second surface 190 to produce the same five marked locations 156 that were originally produced by the first set of pulses 154.

In various embodiments, although laser beam 152 sequentially illuminates only a single marked locations 156 at a given time, because mirror 180 is rotating so quickly for users it appears that each of the marked locations 156 are being constantly and simultaneously illuminated by laser beam 152. Because each marking location 156 is projected multiple times per second, 1 or multiple marking locations 156 can be moved nearly instantly, instead of waiting for a projection head to alter the angle of the marking locations 156, all while leaving the other marking locations 156 at the same location on the work surface 200.

Referring to FIG. 3, control device 130 is communicatively coupled to laser diode 150, and control device 130 is configured to control laser diode 150 to emits a plurality 210 of laser pulses 154 at mirror 180. In various embodiments, control device 130 controls the timing of the plurality 210 of laser pulses 154 so that the plurality 210 of laser pulses 154 produces a plurality of marked locations 156 on a work surface 200 after interfacing with mirror 180 (see FIGS. 1-2).

In various embodiments, control device 130 times laser pulses 154 so that they cycle through marked locations 250, 252, 254, 256, 258 on work surface 200. For example, when laser level 110 is producing five marked locations 156 (e.g., see FIG. 2), pulses 212, 222, 232 and 242 produce marked location 250, pulses 214, 224, and 234 produce marked location 252, pulses 216, 226, and 236 produce marked location 254, pulses 214, 224, and 234 produce marked location 256, and pulses 214, 224, and 234 produce marked location 258. Further, pulses 212, 214, 216, 218, and 2220 interface with first surface 188 (e.g., via reflection) to produce marked locations 156, pulses 222, 224, 226, 228, 230 interface with second surface 190 (e.g., via reflection) to produce marked locations 156, and pulses 232, 234, 236, 238, 240 interface with third surface 192 (e.g., via reflection) to produce marked locations 156.

In various embodiments, mirror 180 includes a plurality of exterior flat surfaces 186 and each pulse 154 of a first subset (e.g., pulses 212, 214, 216, 218, 220) of the plurality 210 of laser pulses 154 interfaces with a first surface (e.g., surface 188) of the plurality of exterior flat surfaces 186 to produce each of the plurality of marked locations 250, 252, 254, 256, 258 on work surface 200. In various embodiments, each pulse 154 of a second subset (e.g., pulses 222, 224, 226, 228, 230) of the plurality 210 of laser pulses 154 distinct from the first subset interfaces with a second surface (e.g., surface 190) of the plurality of exterior flat surfaces 186 to produce each of the plurality of marked locations 250, 252, 254, 256, 258 on work surface 200, and first surface 188 is not coplanar with second surface 190. In various embodiments, each pulse 154 of a third subset (e.g., pulses 232, 234, 236, 238, 240) of the plurality 210 of laser pulses 154 interfaces with a third surface (e.g., surface 192) of the plurality of exterior flat surfaces 186 to produce each of the plurality of marked locations 250, 252, 254, 256, 258 on work surface 200, and the third subset of the plurality 210 of laser pulses 154 is distinct from each of the first subset and the second subset, and third surface 192 is not coplanar with either first surface 188 or second surface 190.

In various embodiments, mirror 180 includes a plurality of exterior flat surfaces 186, and each laser pulse 154 of a first subset of the plurality 210 of laser pulses 154 interfaces with different surfaces 186 of the plurality of exterior flat surfaces 186 to produce each of the plurality of marked locations 156 on the work surface 200. For example, laser pulse 212 interfaces with first surface 188 to produce marked location 250, laser pulse 224 interfaces with second surface 190 to produce marked location 252, and laser pulse 226 interfaces with third surface 192 to produce marked location 254.

In various embodiments, control device 130 controls the timing of the plurality 210 of laser pulses 154 so that each pulse 154 of a first subset of the plurality of laser pulses 154 is projected at a different surface 186 of the plurality of exterior flat surfaces 186, and each pulse 154 of the first subset of the plurality of laser pulses 154 intersects a first location (e.g., marked location 250) on work surface 200 after interfacing with mirror 180. For example, pulses 212, 222, and 232 interface with first surface 188, second surface 190, and third surface 192, respectively, to produce marked location 250.

In various embodiments, control device 130 controls the timing of the plurality 210 of laser pulses 154 so that a first subset of the plurality 210 of laser pulses 154 interfaces with the first surface 188 of the plurality of exterior flat surfaces 186 and thereafter each pulse 154 of the first subset of the plurality of laser pulses 154 intersects the same location (e.g., marked location 250) on work surface 200 after interfacing with mirror 180. For example, if mirror 180 includes four surfaces 186, pulses 212 and 242 interface with first surface 186 to produce marked location 250.

In various embodiments, the subsets of laser pulses 154 described herein include three or more pulses 154, such as exactly three pulses 154.

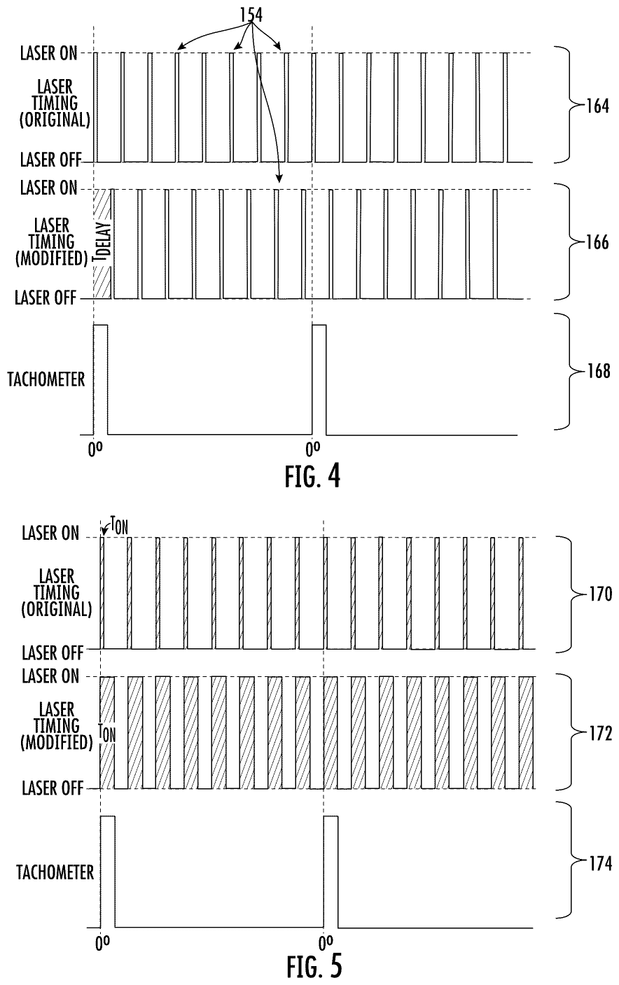

Referring to FIG. 4, various aspects of two series of laser pulses and a delay of the laser pulses are shown. Series 164 is a first series of laser pulses 154, such as a series of laser pulses 154 that project at a single marked location 156. Series 166 is a second series of laser pulses 154, such as a series of laser pulses 154 that project at a single marked location 156 different than the marked location 156 produced by the first series 164. Each of laser pulses 154 in series 166 are delayed by the delays shown in series 168.

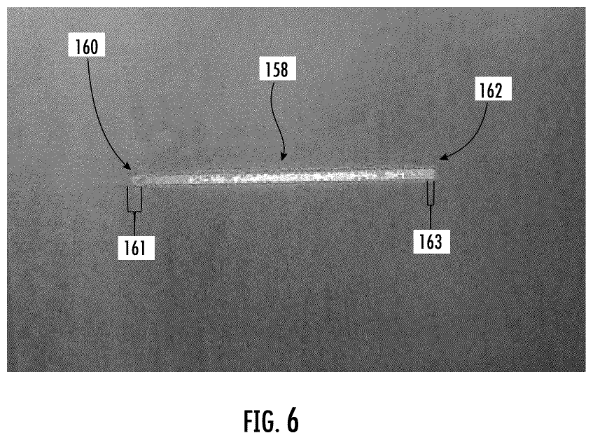

Referring to FIG. 5, various aspects of two series of laser pulses and a lengthening of the laser pulses are shown. Series 170 is a first series of laser pulses 154 at a marked location 156. Series 172 is a second series of laser pulses 154, and each of the laser pulses 154 is longer than compared to series 170, which results in the length of the marked locations 156 being longer (see FIG. 6 for an exemplary marked location 158 of marked locations 156).

Referring to FIG. 6, various aspects of an exemplary marked location 158 of marked locations 156 are shown. Leading edge 160 of marked location 158 (i.e., where the laser pulse 154 starts intersecting the work surface) has a slight gradient compared to trailing edge 162 as there is a non-zero rise time for various embodiments of laser diode 150. In contrast, trailing edge 162 of marked location 156 has a cleaner end compared to leading edge 160 for various embodiments of laser diode 150.

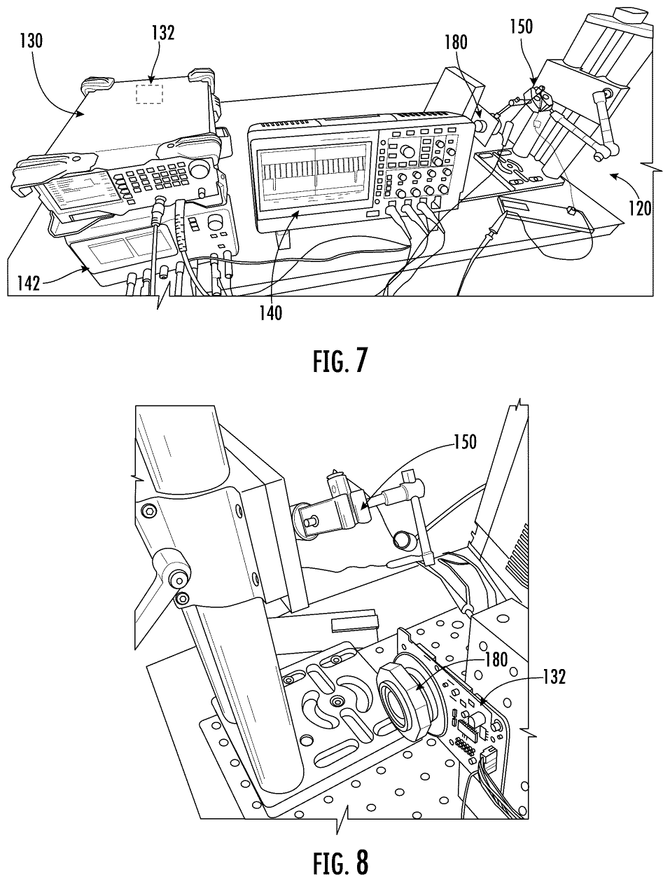

Referring to FIGS. 7-8, various aspects of laser level 110 are shown. Laser level 110 includes housing 120, a laser diode 150 that emits laser pulses 154 of laser beam 152, a control device 130 communicatively coupled to laser diode 150, a tachometer 132 to control the timing of the pulses 154, and power supply 142 to provide power to one or more of the other components in laser level 110. Laser level 110 optionally also includes an oscilloscope 140 to measure and/or display a representation of the pulses 154 being emitted by laser diode 150. In one embodiment, a signal from tachometer 132 is displayed on oscilloscope 140. In various embodiments, control device 130 is configured to control the laser diode 150 to emit a plurality of laser pulses 154 of the laser beam 152 at the mirror 180.

In various embodiments, control device 130 controls the timing of the plurality of laser pulses 154 so that the laser beam 152 produces a plurality of marked locations 156 on a work surface 200, such as a ceiling. In various embodiments, control device 130 controls the timing of the plurality of laser pulses 154 so that (1) each pulse 154 of the plurality of laser pulses 154 is projected at a different surface 186 of the plurality of exterior reflective flat surfaces 186 of mirror 180, and (2) each pulse 154 of the plurality of laser pulses 154 intersects the same location on a work surface 200 (e.g., each pulse 154 intersects work surface 200 at a commonly shared location).

In various embodiments, each of a first subset of a plurality of laser pulses 154 reflect off a first surface (e.g., surface 188) of the plurality of exterior reflective flat surfaces 186 to produce a plurality of marked locations 156 on work surface 200. In various embodiments, each of a second subset of the plurality of laser pulses 154 reflect off a second surface (e.g., surface 190) of the plurality of exterior reflective flat surfaces 186 to produce the same marked locations 156 as previously-produced by the first set of pulses 154, and the first subset is distinct from the second subset, and the first surface 188 is distinct from the second surface 190.

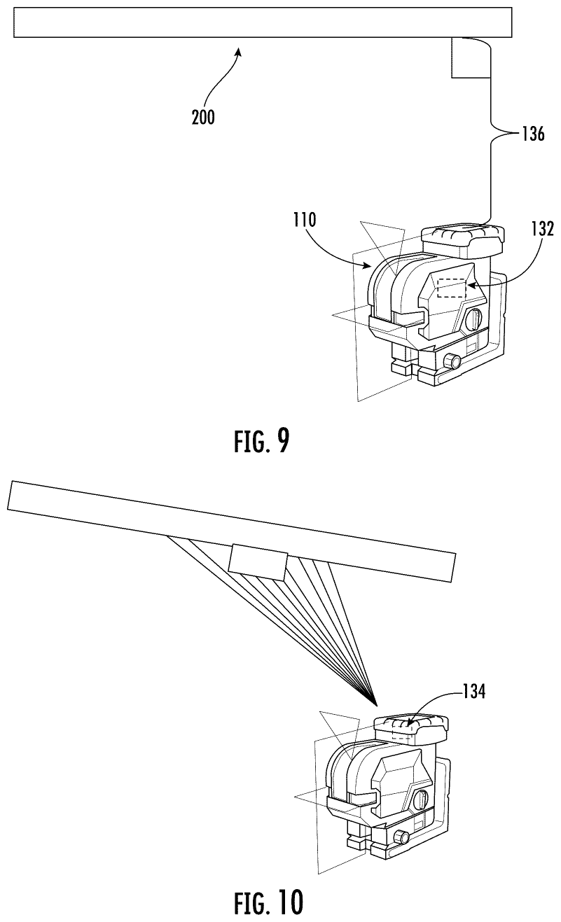

Referring to FIGS. 9-10, various aspects of laser level 110 are shown, where laser level 110 includes a laser distance measurer 134. Laser distance measurer 134 measures height 136 from laser level 110 to work surface 200, such as a ceiling. In various embodiments, laser level 110 assumes that work surface 200 is level and on the same plane as the distance measured directly above laser level 110.

In various embodiments, laser distance measurer 134 takes measurements at multiple locations on ceiling, such as by rotating laser distance measurer 134. Thus, laser distance measurer 134 can provide measurements to laser level 110 so laser level 110 can map the work surface 200 to determine the ceiling slope and any obstacles.

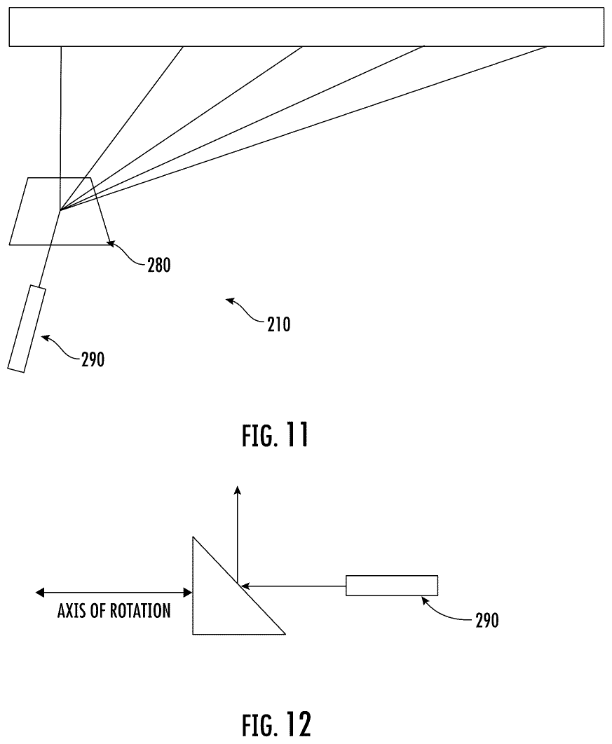

Referring to FIGS. 11-12, various aspects of laser level 210 are shown. Laser level 210 is substantially the same as laser level 110 except for the differences discussed herein. In particular, laser diode 290 emits light towards an oblique planar mirror 280. This approach provides the opportunity for a 360 degree scan angle and allows for a slower switching time for the laser because pulses are not duplicated for multiple sides in one revolution. In various embodiments, a laser distance measurer included in laser level 210 may also reflect light off mirror 280 to measure and/or map a work surface, such as a ceiling, to determine the ceiling slope and any obstacles.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A laser beam generating device comprising:
a housing;
a light directing element that rotates with respect to a rotational axis that extends through the light directing element;
a laser diode configured to emit a laser beam at the light directing element; and
a control device communicatively coupled to the laser diode, the control device configured to control the laser diode to emit a plurality of laser pulses of the laser beam at the light directing element, wherein the control device controls the timing of the plurality of laser pulses so that the plurality of laser pulses produces a plurality of marked locations on a work surface after interfacing with the light directing element.

2. The laser beam generating device of claim 1, wherein the light directing element comprises a plurality of exterior flat surfaces, and wherein each pulse of a first subset of the plurality of laser pulses interfaces with a first surface of the plurality of exterior flat surfaces to produce each of the plurality of marked locations on the work surface.

3. The laser beam generating device of claim 2, wherein each pulse of a second subset of the plurality of laser pulses distinct from the first subset interfaces with a second surface of the plurality of exterior flat surfaces to produce each of the plurality of marked locations on the work surface, wherein the first surface is not coplanar with the second surface.

4. The laser beam generating device of claim 3, wherein each pulse of a third subset of the plurality of laser pulses interfaces with a third surface of the plurality of exterior flat surfaces to produce each of the plurality of marked locations on the work surface, wherein the third subset of the plurality of laser pulses is distinct from each of the first subset and the second subset, and wherein the third surface is not coplanar with either the first surface or the second surface.

5. The laser beam generating device of claim 2, wherein the plurality of exterior flat surfaces circumferentially surround and face away from the rotational axis.

6. The laser beam generating device of claim 5, wherein the plurality of exterior flat surfaces are symmetrically arranged around the rotational axis, and wherein the rotational axis is a horizontal axis.

7. The laser beam generating device of claim 2, wherein the light directing element comprises a mirror, wherein the plurality of exterior flat surfaces comprise a plurality of exterior reflective flat surfaces, and wherein the plurality of laser pulses interfacing with the light directing element comprises the plurality of laser pulses reflecting off the plurality of exterior reflective flat surfaces.

8. The laser beam generating device of claim 1, wherein the light directing element comprises a mirror, and wherein the plurality of laser pulses interfacing with the light directing element comprises the plurality of laser pulses reflecting off the mirror.

9. The laser beam generating device of claim 1, wherein the work surface is a ceiling.

10. The laser beam generating device of claim 1, wherein the light directing element comprises a plurality of exterior flat surfaces, and wherein each pulse of a first subset of the plurality of laser pulses interfaces with different surfaces of the plurality of exterior flat surfaces to produce each of the plurality of marked locations on the work surface.

11. A laser beam generating device comprising:
a housing;
a light directing element that rotates with respect to a rotational axis that extends through the light directing element, the light directing element comprising a plurality of exterior flat surfaces;
a laser diode configured to emit a laser beam at the light directing element; and
a control device communicatively coupled to the laser diode, the control device configured to control the laser diode to emit a plurality of laser pulses of the laser beam at the light directing element, wherein the control device controls the timing of the plurality of laser pulses so that:
each pulse of a first subset of the plurality of laser pulses is projected at a different surface of the plurality of exterior flat surfaces; and
each pulse of the first subset of the plurality of laser pulses intersects a first location on a work surface after interfacing with the light directing element.

12. The laser beam generating device of claim 11, wherein the work surface is a ceiling.

13. The laser beam generating device of claim 11, wherein the first subset of the plurality of laser pulses comprises at least three laser pulses.

14. The laser beam generating device of claim 11, wherein the plurality of exterior flat surfaces circumferentially surround and face away from the rotational axis.

15. The laser beam generating device of claim 14, wherein the plurality of exterior flat surfaces are symmetrically arranged around the rotational axis.

16. The laser beam generating device of claim 11, wherein the light directing element comprises a mirror, and wherein the plurality of laser pulses interfacing with the light directing element comprises the plurality of laser pulses reflecting off the mirror.

17. A laser beam generating device comprising:
a housing;
a light directing element that rotates with respect to a rotational axis that extends through the light directing element, the light directing element comprising a plurality of exterior flat surfaces;
a laser diode configured to emit a laser beam at the light directing element; and
a control device communicatively coupled to the laser diode, the control device configured to control the laser diode to emit a plurality of laser pulses of the laser beam at a first surface of the plurality of exterior flat surfaces, wherein the control device controls the timing of the plurality of laser pulses so that a first subset of the plurality of laser pulses interfaces with the first surface of the plurality of exterior flat surfaces and thereafter each pulse of the first subset of the plurality of laser pulses intersects the same location on a work surface after interfacing with the light directing element.

18. The laser beam generating device of claim 17, wherein the plurality of exterior flat surfaces circumferentially surround and face away from the rotational axis.

19. The laser beam generating device of claim 18, wherein the plurality of exterior flat surfaces are symmetrically arranged around the rotational axis.

20. The laser beam generating device of claim 17, wherein the light directing element comprises a mirror, and wherein the plurality of laser pulses interfacing with the light directing element comprises the plurality of laser pulses reflecting off the mirror.
